(19) United States
(12) Patent Application Publication
(10) Pub. No.: US 2014/0185496 A1
(43) Pub. Date: Jul. 3, 2014

(54) LOW LATENCY ARQ/HARQ OPERATING IN CARRIER AGGREGATION FOR BACKHAUL LINK

(71) Applicant: QUALCOMM Incorported, San Dieog, CA (US)

(72) Inventors: Guy Wolf, Hod Hasharon (IL); Assaf Touboul, Netania (IL)

(73) Assignee: QUALCOMM Incorported, San Diego, CA (US)

(21) Appl. No.: 14/107,885

(22) Filed: Dec. 16, 2013

Related U.S. Application Data
(60) Provisional application No. 61/748,329, filed on Jan. 2, 2013.

(51) Int. Cl. H04W 72/04; H04L 5/00; H04Q 11/04

(52) U.S. Cl. CPC H04W 72/0493; H04Q 11/0428; H04L 5/0048
USPC 370/294

(57) ABSTRACT

Described embodiments reduce ARQ/HARQ latency using carrier aggregation and cross-carrier ARQ/HARQ signaling. In embodiments, a wireless backhaul transmission link uses multiple paired carriers with complementary TDD frame timing. In embodiments, backhaul traffic subframes are protected using FEC and/or CRC encoding and ACK/NACK information is generated based on decoding and computing the FEC and/or CRC information for the subframes. The ACK/NACK information may be transmitted on the paired carrier. In embodiments, cross-carrier ARQ/HARQ signaling may reduce ARQ/HARQ latency to less than two TDD subframes.

### CROSS REFERENCES

The present application for patent claims priority to co-pending U.S. Provisional Patent Application No. 61/748,329 by Wolf et al., entitled “Low Latency ARQ/HARQ Operating in Carrier Aggregation for Backhaul Link,” filed Jan. 2, 2013, assigned to the assignee hereof, and expressly incorporated by reference herein.

### BACKGROUND

Wireless communication networks are widely deployed to provide various communication services such as voice, video, packet data, messaging, broadcast, and the like.

Wireless communication networks that include a number of base stations to provide coverage over a wide geographic area may be called cellular networks. These cellular networks may be multiple-access networks capable of supporting multiple users by sharing the available network resources.

Cellular networks have employed the use of various cell types, such as macrocells, microcells, picocells, and femtocells, to provide desired bandwidth, capacity, and wireless communication coverage within service areas. Some of the various types of cells may be used to provide wireless communication in areas of poor network coverage (e.g., inside of buildings), to provide increased network capacity, and to utilize broadband network capacity for backhaul. It may be desirable to distribute cells in areas where a direct network connection for providing backhaul is not available. Providing wireless backhaul to these cells provides challenges because of the high quality of service (QoS) requirements and limited backhaul spectrum availability.

Spectrum bands that permit unlicensed use have great potential for wireless backhaul. In the United States for example, unlicensed spectrum bands include spectrum around 915 MHz, 2.4 GHz, 3.4-3.8 GHz, 5 GHz, and 5.8 GHz in some areas. However, use of unlicensed spectrum bands presents challenges with regard to preserving channel reliability for carrier-grade deployments in the presence of licensed users and/or other wireless devices such as wireless local area network (WLAN) devices sharing the spectrum. For example, some bands may have primary users that have priority for use of channels within the band. Some bands may require unlicensed devices to detect the presence of licensed users and vacate the channel if the licensed users are detected. For example, Dynamic Frequency Selection (DFS) is a mechanism that allows unlicensed devices to use some bands already allocated to other uses without causing interference to the primary users. In addition, neighboring devices sharing the unlicensed band may generate bursty interference which may result in poor channel reliability. These and other issues may prevent effective deployment of carrier-grade wireless backhaul using unlicensed spectrum bands.

### SUMMARY

The described features generally relate to one or more improved systems, methods, and/or apparatuses for reducing ARQ/HARQ latency using carrier aggregation and cross-carrier ARQ/HARQ signaling. In embodiments, a wireless backhaul transmission link uses multiple paired carriers with complementary TDD subframe timing. In embodiments, backhaul traffic subframes are protected using forward error correction (FEC) and/or cyclic redundancy checking (CRC) encoding. A backhaul traffic subframe is received over a first carrier of a paired set of TDD carriers and ACK/NACK information is generated based on decoding and computing the FEC and/or CRC information for the subframe. The ACK/NACK information may be transmitted on the second paired carrier during a transmission subframe on the paired carrier that corresponds to a receive subframe on the first carrier. In embodiments, cross-carrier ARQ/HARQ signaling reduces ARQ/HARQ latency to less than two TDD subframes.

In a first set of illustrative embodiment, a method for wireless backhaul communications in a wireless communications network is described. The method may include receiving, at a first node of the wireless communications network, a first backhaul subframe over a first time division duplexed carrier of a wireless backhaul communications link between the first node and a second node of the wireless communications network. The method may further include decoding the first backhaul subframe and generating a first acknowledgement/negative acknowledgement (ACK/NACK) indicator based on the decoded first backhaul subframe. Thereafter, the method may include transmitting, from the first node to the second node, the first ACK/NACK indicator over a second time division duplexed carrier of the wireless backhaul communications link and transmitting, within at least a partially overlapping subframe period corresponding to reception of the first backhaul subframe, a second backhaul subframe over the second carrier to the second node.

In certain examples, the method includes receiving, within at least a partially overlapping subframe period corresponding to transmitting the first ACK/NACK indicator for the first backhaul subframe, a second ACK/NACK indicator associated with reception at the second node of the second backhaul subframe. The method may include modulating and coding, at the first node, a second backhaul subframe for transmission during a subframe period immediately following reception of the first backhaul subframe, where the modulation and coding of the second backhaul subframe is performed prior to completion of the decoding of the first backhaul subframe. The first node may provide access for a plurality of user equipments (UEs) using a multiple access radio technology over a licensed spectrum band. The first node may be, for example, a femto base station or macro base station of the wireless communications network.

At the first node, the method may further comprise filtering the transmission of the second backhaul subframe within at least the partially overlapping subframe period corresponding to reception of the first backhaul subframe. Transmission periods for the first node on the second time division duplexed carrier may at least partially overlap with reception periods for the first node on the first time division duplexed carrier. Decoding the first backhaul subframe may include performing a cyclic redundancy check (CRC) on the first backhaul subframe.

In further example, the first ACK/NACK indicator is transmitted within a transmission subframe of the second time division duplexed carrier less than two subframe periods after receiving the first backhaul subframe. Where the first ACK/NACK indicator indicates unsuccessful receipt of the first backhaul subframe at the first node, the method may include receiving a re-transmission of the first backhaul subframe from the second node over the first time division duplexed carrier. In embodiments, the first and second time division duplexed carriers include carriers of a shared spectrum band open for use by wireless local area networks (WLANs). The first and second time division duplexed carriers may be adjacent carriers.

In still further example, the method may include receiving, at the first node, a second backhaul subframe over a third time division duplexed carrier between the first node and the second node. The method may provide decoding the second backhaul subframe and generating a second ACK/NACK indicator from the decoded second backhaul subframe. The second ACK/NACK indicator may be transmitted from the first node to the second node over a fourth time division duplexed carrier, wherein transmission periods for the first node on the fourth time division duplexed carrier at least partially overlap with reception periods for the first node on the third time division duplexed carrier.

According to a second set of illustrative embodiment, a computer program product for wireless backhaul between a first node and a second node of a wireless communications network may be described. The computer program may include a non-transitory computer-readable medium including code for causing a computer to receive, at the first node, a first backhaul subframe over a first time division duplexed carrier of a wireless backhaul communications link between the first node and the second node and code for causing the computer to decode the first backhaul subframe. The second set of illustrative embodiment may further include code for causing the computer to generate a first acknowledgement/negative acknowledgement (ACK/NACK) indicator based on the decoded first backhaul subframe, and code for causing the computer to transmit, from the first node to the second node, the first ACK/NACK indicator over a second time division duplexed carrier of the wireless backhaul communications link. The non-transitory computer-readable medium may further include code for causing the computer to transmit, within at least a partially overlapping subframe period corresponding to reception of the first backhaul subframe, a second backhaul subframe over the second carrier to the second node. In certain examples, the computer program product may further implement one or more aspects of the method for wireless backhaul communication described above with respect to the first set of illustrative embodiments.

According to a third set of illustrative embodiment, a communications device for wireless backhaul communications between a first node and a second node of a wireless communications network may include at least one processor configured to receive, at the first node, a first backhaul subframe over a first time division duplexed carrier of a wireless backhaul communications link between the first node and the second node. The at least one processor may be configured to decode the first backhaul subframe and generate a first acknowledgement/negative acknowledgement (ACK/NACK) indicator based on the decoded first backhaul subframe. The first ACK/NACK indicator may be transmitted from the first node to the second node over a second time division duplexed carrier of the wireless backhaul communications link. The at least one processor may be further configured to transmit, within at least a partially overlapping subframe period corresponding to reception of the first backhaul subframe, a second backhaul subframe over the second carrier to the second node. In certain examples, the instructions may be further executable by the processor to implement one or more aspects of the method for wireless backhaul communication described above with respect to the first set of illustrative embodiments.

Further scope of the applicability of the described methods and apparatuses will become apparent from the following detailed description, claims and drawings. The detailed description and specific examples are given by way of illustration only, as various changes and modifications within the spirit and scope of the description will become apparent to those skilled in the art.

### BRIEF DESCRIPTION OF THE DRAWINGS

A further understanding of the nature and advantages of the present invention may be realized by reference to the following drawings. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 is a diagram illustrating an example of a wireless communications system in accordance with various embodiments;

FIG. 2 is a diagram illustrating an LTE/LTE-Advanced network architecture in accordance with various embodiments;

FIG. 3 illustrates aspects of a wireless communications network for supporting wireless backhaul in accordance with various embodiments;

FIG. 4 illustrates a protocol architecture for wired and/or wireless backhaul transmissions in accordance with various embodiments;

FIG. 5 illustrates a block diagram of a system for reducing ARQ/HARQ latency in wireless backhaul in accordance with various embodiments;

FIG. 6 illustrates a timing diagram for reducing ARQ/HARQ latency in wireless backhaul using paired TDD carriers in accordance with various embodiments;

FIG. 7 shows a block diagram of a device that may be employed for reducing ARQ/HARQ latency in wireless backhaul using paired TDD carriers in accordance with various embodiments;

FIG. 8 shows a block diagram of a communications system that may be configured for supporting wireless backhaul in accordance with various embodiments.

FIG. 9 illustrates a method for reducing ARQ/HARQ latency in wireless backhaul using paired TDD carriers in accordance with various embodiments; and

FIG. 10 illustrates a method for reducing ARQ/HARQ latency in wireless backhaul using paired TDD carriers in accordance with various embodiments.

### DETAILED DESCRIPTION

Described embodiments are directed to systems and methods for reducing ARQ/HARQ latency using carrier aggregation and cross-carrier ARQ/HARQ signaling. In embodiments, a wireless backhaul transmission link uses multiple paired carriers with complementary TDD subframe timing. In embodiments, backhaul traffic subframes are protected using FEC and/or CRC encoding. A backhaul traffic subframe is received over a first carrier of a paired set of TDD carriers and ACK/NACK information is generated based on decoding and computing the FEC and/or CRC information for the subframe. The ACK/NACK information may be transmitted on the second paired carrier during a transmission subframe on the paired carrier that corresponds to a receive subframe on the first carrier. In embodiments, cross-carrier ARQ/HARQ signaling reduces ARQ/HARQ latency to less than two TDD subframes.

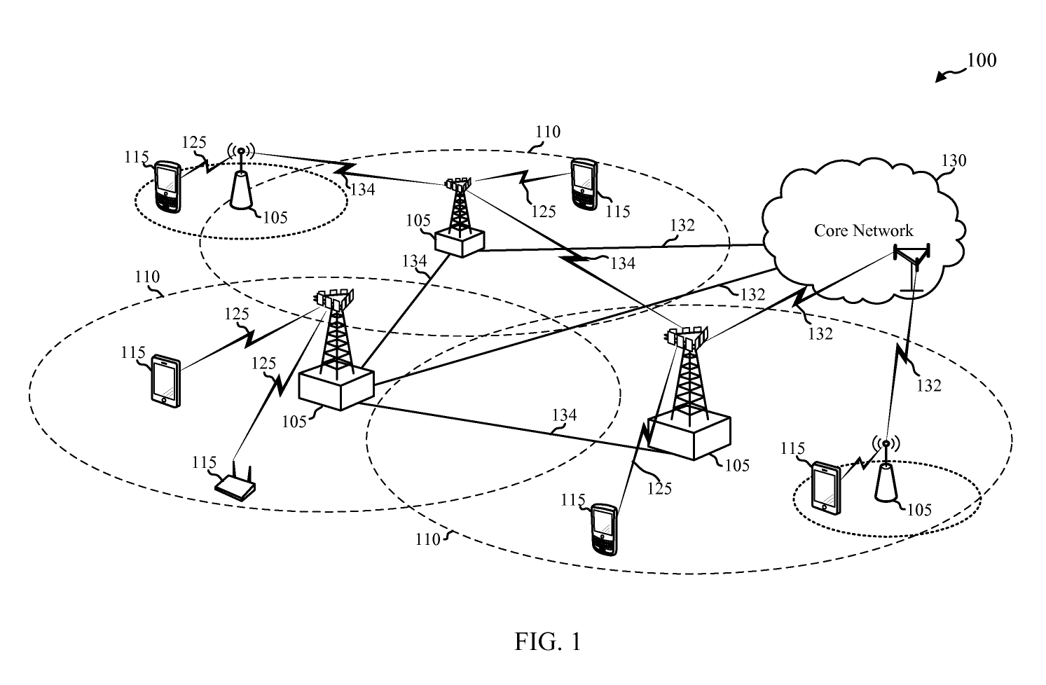

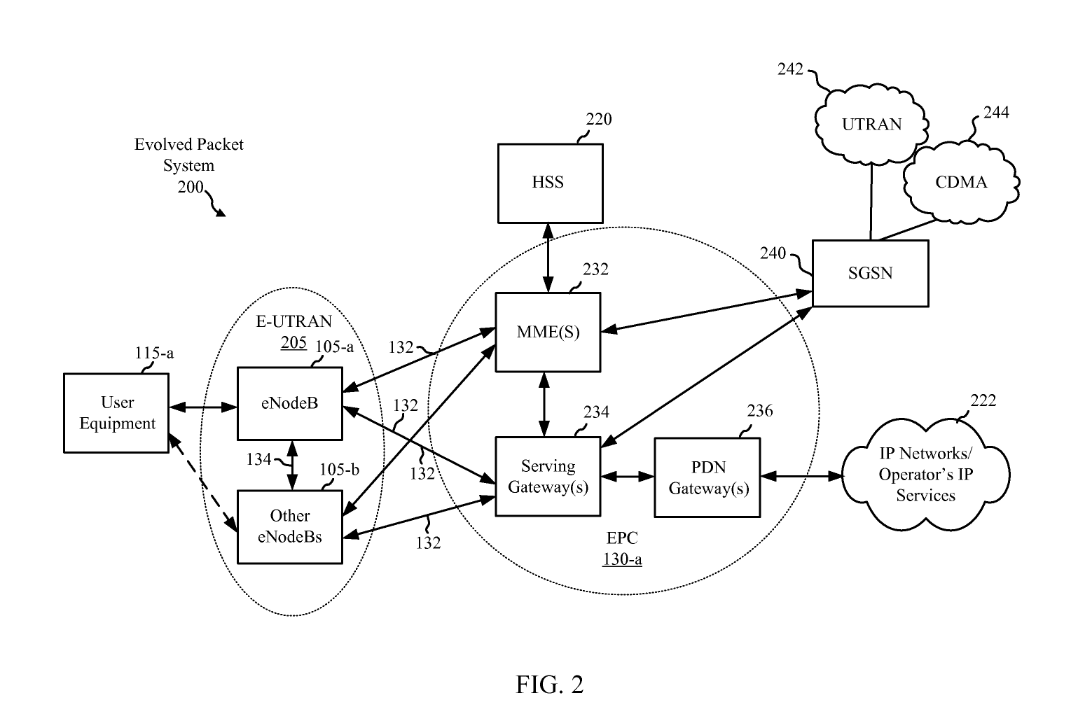

In embodiments, a duplexing filter is configured to reject out-of-band noise from transmission subframes on each of the paired complementary TDD carriers. The duplexing filter may be configured to filter each paired carrier on alternating TDD subframes. The described techniques may be used to provide wireless backhaul for nodes of the wireless communication networks 100 and/or 200 of FIG. 1 and/or FIG. 2. The described techniques may be used to provide wireless backhaul between Feeder Base Stations and Remote Base Stations in wireless communication networks. The described techniques may also be used for inter-eNB wireless backhaul. The described techniques may be used to provide wireless backhaul over unlicensed spectrum bands.

Techniques described herein may be used for various wireless communications systems such as cellular wireless systems, Peer-to-Peer wireless communications, wireless local access networks (WLANs), ad hoc networks, satellite communications systems, and other systems. The terms “system” and “network” are often used interchangeably. Also, as used herein, including in the claims, the term “partially” is used interchangeably with “substantially.” These wireless communications systems may employ a variety of radio communication technologies such as Code Division Multiple Access (CDMA), Time Division Multiple Access (TDMA), Frequency Division Multiple Access (FDMA), Orthogonal FDMA (OFDMA), Single-Carrier FDMA (SC-FDMA), and/or other radio technologies. Generally, wireless communications are conducted according to a standardized implementation of one or more radio communication technologies called a Radio Access Technology (RAT). A wireless communications system or network that implements a Radio Access Technology may be called a Radio Access Network (RAN).

Examples of Radio Access Technologies employing CDMA techniques include CDMA2000, Universal Terrestrial Radio Access (UTRA), etc. CDMA2000 covers IS-2000, IS-95, and IS-856 standards. IS-2000 Releases 0 and A are commonly referred to as CDMA2000 1X, 1X, etc. IS-856 (TIA-856) is commonly referred to as CDMA2000 1xEV-DO, High Rate Packet Data (HRPD), etc. UTRA includes Wideband CDMA (WCDMA) and other variants of CDMA. Examples of TDMA systems include various implementations of Global System for Mobile Communications (GSM). Examples of Radio Access Technologies employing OFDM and/or OFDMA include Ultra Mobile Broadband (UMB), Evolved UTRA (E-UTRA), IEEE 802.11 (Wi-Fi), IEEE 802.16 (WiMAX), IEEE 802.20, Flash-OFDM, etc. UTRA and E-UTRA are part of Universal Mobile Telecommunication System (UMTS). 3GPP Long Term Evolution (LTE) and LTE-Advanced (LTE-A) are new releases of UMTS that use E-UTRA. UTRA, E-UTRA, UMTS, LTE, LTE-A, and GSM are described in documents from an organization named “3rd Generation Partnership Project” (3GPP). CDMA2000 and UMB are described in documents from an organization named “3rd Generation Partnership Project 2” (3GPP2). The techniques described herein may be used for the systems and radio technologies mentioned above as well as other systems and radio technologies.

Thus, the following description provides examples, and is not limiting of the scope, applicability, or configuration set forth in the claims. Changes may be made in the function and arrangement of elements discussed without departing from the spirit and scope of the disclosure. Various embodiments may omit, substitute, or add various procedures or components as appropriate. For instance, the methods described may be performed in an order different from that described, and various steps may be added, omitted, or combined. Also, features described with respect to certain embodiments may be combined in other embodiments.

Referring first to FIG. 1, a diagram illustrates an example of a wireless communications system 100. The system 100 includes base stations (or cells) 105, communication devices 115, and a core network 130. The base stations 105 may communicate with the communication devices 115 under the control of a base station controller (not shown), which may be part of the core network 130 or the base stations 105 in various embodiments. Base stations 105 may communicate control information and/or user data with the core network 130 through backhaul links 132. Backhaul links may be wired backhaul links (e.g., copper, fiber, etc.) and/or wireless backhaul links (e.g., microwave, etc.). In embodiments, the base stations 105 may communicate, either directly or indirectly, with each other over backhaul links 134, which may be wired or wireless communication links. The system 100 may support operation on multiple carriers (waveform signals of different frequencies). Multi-carrier transmitters can transmit modulated signals simultaneously on the multiple carriers. For example, each communication link 125 may be a multi-carrier signal modulated according to the various radio technologies described above. Each modulated signal may be sent on a different carrier and may carry control information (e.g., reference signals, control channels, etc.), overhead information, data, etc.

The base stations 105 may wirelessly communicate with the devices 115 via one or more base station antennas. Each of the base station 105 sites may provide communication coverage for a respective geographic area 110. In some embodiments, base stations 105 may be referred to as a base transceiver station, a radio base station, an access point, a radio transceiver, a basic service set (BSS), an extended service set (ESS), a NodeB, eNodeB (eNB), Home NodeB, a Home eNodeB, or some other suitable terminology. The coverage area 110 for a base station may be divided into sectors making up only a portion of the coverage area (not shown). The system 100 may include base stations 105 of different types (e.g., macro, micro, and/or pico base stations). There may be overlapping coverage areas for different technologies.

In embodiments, the system 100 is an LTE/LTE-A network. In LTE/LTE-A networks, the terms evolved Node B (eNB) and user equipment (UE) may be generally used to describe the base stations 105 and devices 115, respectively. The system 100 may be a Heterogeneous LTE/LTE-A network in which different types of eNBs provide coverage for various geographical regions. For example, each eNB 105 may provide communication coverage for a macro cell, a pico cell, a femto cell, and/or other types of cell. A macro cell generally covers a relatively large geographic area (e.g., several kilometers in radius) and may allow unrestricted access by UEs with service subscriptions with the network provider. A pico cell would generally cover a relatively smaller geographic area and may allow unrestricted access by UEs with service subscriptions with the network provider. A femto cell would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). An eNB for a macro cell may be referred to as a macro eNB. An eNB for a pico cell may be referred to as a pico eNB. And, an eNB for a femto cell may be referred to as a femto eNB or a home eNB. An eNB may support one or multiple (e.g., two, three, four, and the like) cells.

The wireless network 100 may support synchronous or asynchronous operation. For synchronous operation, the eNBs may have similar frame timing, and transmissions from different eNBs may be approximately aligned in time. For asynchronous operation, the eNBs may have different frame timing, and transmissions from different eNBs may not be aligned in time. The techniques described herein may be used for either synchronous or asynchronous operations.

The UEs 115 are dispersed throughout the wireless network 100, and each UE may be stationary or mobile. A UE 115 may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. A UE 115 may be a cellular phone, a personal digital assistant (PDA), a wireless modem, a wireless communication device, a handheld device, a tablet computer, a laptop computer, a cordless phone, a wireless local loop (WLL) station, or the like. A UE may be able to communicate with macro eNBs, pico eNBs, femto eNBs, relays, and the like.

The transmission links 125 shown in network 100 may include uplink (UL) transmissions from a mobile device 115 to a base station 105, and/or downlink (DL) transmissions, from a base station 105 to a mobile device 115. The downlink transmissions may also be called forward link transmissions while the uplink transmissions may also be called reverse link transmissions.

The core network 130 may communicate with the eNBs 105 via backhaul links 132 (e.g., S1 interface, etc.). The eNBs 105 may also communicate with one another, directly or indirectly, via backhaul links 134 (e.g., inter-eNB backhaul, X2 interface, etc.) and/or via backhaul links 132 (e.g., through core network 130). To provide a wide coverage area, some eNBs 105 may be located in places that do not have an existing backhaul infrastructure. In these instances, it may be difficult or expensive to provide wired backhaul between the eNBs 105 and the core network 130 and/or between eNBs 105 and other eNBs 105.

In various instances, backhaul links 132, 134 may be wireless backhaul links. Because of high QoS requirements, carrier-grade backhaul links generally use licensed or dedicated spectrum bands that are substantially free from other interfering devices. However, in many circumstances, licensed spectrum bands for wireless backhaul may be difficult or expensive to acquire. Many countries and regions have, in addition to licensed spectrum bands that are dedicated to a particular use or entity, unlicensed spectrum bands that may be used in a variety of ways. While unlicensed spectrum bands may not be dedicated to a particular use or provider, interference in the bands may be mitigated by technical rules governing both the hardware and deployment methods of radios using the band. The rules vary from band to band and countries have varying rules governing operational requirements and/or maximum transmission power in unlicensed bands.

Unlicensed spectrum bands may be divided into pre-defined frequency ranges or sub-bands. Generally, these frequency ranges are referred to herein as carriers, but may also be referred to as channels. Carriers may be overlapping or non-overlapping and may be made up of one or more sub-carriers (e.g., OFDM tones, etc.).

Common uses of unlicensed spectrum include cordless phones, garage door openers, wireless microphones, and wireless computer networking. Wireless computer networks include ad-hoc networks, personal area networks (e.g., Bluetooth, etc.), peer-to-peer networking, mesh networks, and WLANs. Most modern WLANs are based on IEEE 802.11 standards. These networks may also be known as “Wi-Fi” networks.

While offering potential for use in wireless backhaul, use of unlicensed spectrum bands in wireless backhaul presents significant challenges. In particular, carrier-grade communications have QoS requirements that are significantly higher than those of other unlicensed band communications such as wireless networking. In addition, point-to-point wireless backhaul systems typically use different communication protocols than wireless networking devices sharing the unlicensed spectrum bands.

The different aspects of system 100, such as the eNBs 105 and/or core network 130, may be configured to reduce ARQ/HARQ latency using carrier aggregation and cross-carrier ARQ/HARQ signaling. In embodiments, a wireless backhaul transmission link uses multiple paired carriers with complementary TDD subframe timing. In embodiments, backhaul traffic subframes are protected using FEC and/or CRC encoding. A backhaul traffic subframe is received over a first carrier of a paired set of TDD carriers and ACK/NACK information is generated based on decoding and computing the FEC and/or CRC information for the subframe. The ACK/NACK information may be transmitted on the second paired carrier during a transmission subframe on the paired carrier that corresponds to a receive subframe on the first carrier. In embodiments, cross-carrier ARQ/HARQ signaling reduces ARQ/HARQ latency to less than two TDD subframes.

In embodiments, a duplexing filter is configured to reject out-of-band noise from transmission subframes on each of the paired complementary TDD carriers. The duplexing filter may be configured to filter each paired carrier on alternating TDD subframes. The described techniques may be used to provide wireless backhaul for nodes of the wireless communication networks 100 and/or 200 of FIG. 1 and/or FIG. 2. The described techniques may be used to provide wireless backhaul between Feeder Base Stations and Remote Base Stations in wireless communication networks. The described techniques may also be used for inter-eNB wireless backhaul. The described techniques may be used to provide wireless backhaul over unlicensed spectrum bands.

FIG. 2 is a diagram illustrating an LTE/LTE-Advanced network architecture 200 in accordance with various embodiments. The LTE/LTE-A network architecture 200 may be referred to as an Evolved Packet System (EPS) 200. The EPS 200 may include one or more UEs 115, an Evolved UMTS Terrestrial Radio Access Network (E-UTRAN) 205, an Evolved Packet Core (EPC) 130-a, a Home Subscriber Server (HSS) 220, and an Operator's IP Services 222. The EPS 200 may interconnect with other access networks, but for simplicity those entities/interfaces are not shown. As shown, the EPS 200 provides packet-switched services, however, as those skilled in the art will readily appreciate, the various concepts presented throughout this disclosure may be extended to networks providing circuit-switched services.

The E-UTRAN 205 may include an eNB 105-a and other eNBs 105-b. The eNB 105-a may provide user plane and control plane protocol terminations toward the UE 115-a. The eNB 105-a may be connected to the other eNBs 105-b via an X2 interface (e.g., backhaul link 134). The eNB 105-a may provide an access point to the EPC 130-a for the UE 115-a. The eNB 105-a may be connected by an S1 interface (e.g., backhaul link 132) to the EPC 130-a. The EPC 130-a may include one or more Mobility Management Entities (MMES) 232, one or more Serving Gateways 234, and one or more Packet Data Network (PDN) Gateways 236. The MME 232 may be the control node that processes the signaling between the UE 115-a and the EPC 130-a. Generally, the MME 232 may provide bearer and connection management. All user IP packets may be transferred through the Serving Gateway 234, which itself may be connected to the PDN Gateway 236. The PDN Gateway 236 may provide UE IP address allocation as well as other functions. The PDN Gateway 236 may be connected to IP networks and/or Operator's IP Services 222. The IP Networks/Operator's IP Services 222 may include the Internet, an Intranet, an IP Multimedia Subsystem (IMS), and/or a Packet-Switched (PS) Streaming Service (PSS). The EPS 200 may interconnect with other access networks using other Radio Access Technologies. For example, EPS 200 may interconnect with UTRAN network 242 and/or CDMA network 244 via one or more Serving GPRS Support Nodes (SGSNs) 240.

The UE 115-a may be configured to collaboratively communicate with multiple eNBs 105 through, for example, Multiple Input Multiple Output (MIMO), Coordinated Multi-Point (CoMP), or other schemes. MIMO techniques use multiple antennas on the base stations and/or multiple antennas on the UE to take advantage of multipath environments to transmit multiple data streams. CoMP includes techniques for dynamic coordination of transmission and reception by a number of eNBs to improve overall transmission quality for UEs as well as increasing network and spectrum utilization. Generally, CoMP techniques utilize backhaul links 132 and/or 134 for communication between base stations 105 to coordinate control plane and user plane communications for the UEs 115.

The communication networks that may accommodate some of the various disclosed embodiments may be packet-based networks that operate according to a layered protocol stack. For example, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use Hybrid ARQ (HARM) to provide retransmission at the MAC layer to improve link efficiency. At the Physical layer, the transport channels may be mapped to Physical channels.

LTE/LTE-A utilizes orthogonal frequency division multiple-access (OFDMA) on the downlink and single-carrier frequency division multiple-access (SC-FDMA) on the uplink. OFDMA and SC-FDMA partition the system bandwidth into multiple (K) orthogonal subcarriers, which are also commonly referred to as tones, bins, or the like. Each subcarrier may be modulated with data. The spacing between adjacent subcarriers may be fixed, and the total number of subcarriers (K) may be dependent on the system bandwidth. For example, K may be equal to 72, 180, 300, 600, 900, or 1200 with a subcarrier spacing of 15 kilohertz (KHz) for a corresponding system bandwidth (with guardband) of 1.4, 3, 5, 10, 15, or 20 megahertz (MHz), respectively. The system bandwidth may also be partitioned into sub-bands. For example, a sub-band may cover 1.08 MHz, and there may be 1, 2, 4, 8 or 16 sub-bands.

Wireless networks 100 and/or 200 may support operation on multiple carriers, which may be referred to as carrier aggregation (CA) or multi-carrier operation. A carrier may also be referred to as a component carrier (CC), a channel, etc. The terms “carrier,” “CC,” and “channel” may be used interchangeably herein. A carrier used for the downlink may be referred to as a downlink CC, and a carrier used for the uplink may be referred to as an uplink CC. A UE may be configured with multiple downlink CCs and one or more uplink CCs for carrier aggregation. An eNB may transmit data and control information on one or more downlink CCs to the UE. The UE may transmit data and control information on one or more uplink CCs to the eNB.

One or more of the backhaul links 132 and/or 134 of wireless networks 100 and/or 200 may be wireless backhaul links utilizing unlicensed spectrum bands. The wireless networks 100 and/or 200 may be configured to reduce ARQ/HARQ latency using carrier aggregation and cross-carrier ARQ/HARQ signaling. In embodiments, backhaul links 132 and/or 134 may be wireless backhaul links utilizing multiple paired carriers with complementary TDD subframe timing. In embodiments, backhaul traffic subframes are protected using FEC and/or CRC encoding. A backhaul traffic subframe is received over a first carrier of a paired set of TDD carriers and ACK/NACK information is generated based on decoding and computing the FEC and/or CRC information for the subframe. The ACK/NACK information may be transmitted on the second paired carrier during a transmission subframe on the paired carrier that corresponds to a receive subframe on the first carrier. In embodiments, cross-carrier ARQ/HARQ signaling reduces ARQ/HARQ latency to less than two TDD subframes.

In embodiments, a duplexing filter is configured to reject out-of-band noise from transmission subframes on each of the paired complementary TDD carriers. The duplexing filter may be configured to filter each paired carrier on alternating TDD subframes. The described techniques may be used to provide wireless backhaul for nodes of the wireless communication networks 100 and/or 200 of FIG. 1 and/or FIG. 2. The described techniques may be used to provide wireless backhaul between Feeder Base Stations and Remote Base Stations in wireless communication networks. The described techniques may also be used for inter-eNB wireless backhaul. The described techniques may be used to provide wireless backhaul over unlicensed spectrum bands.

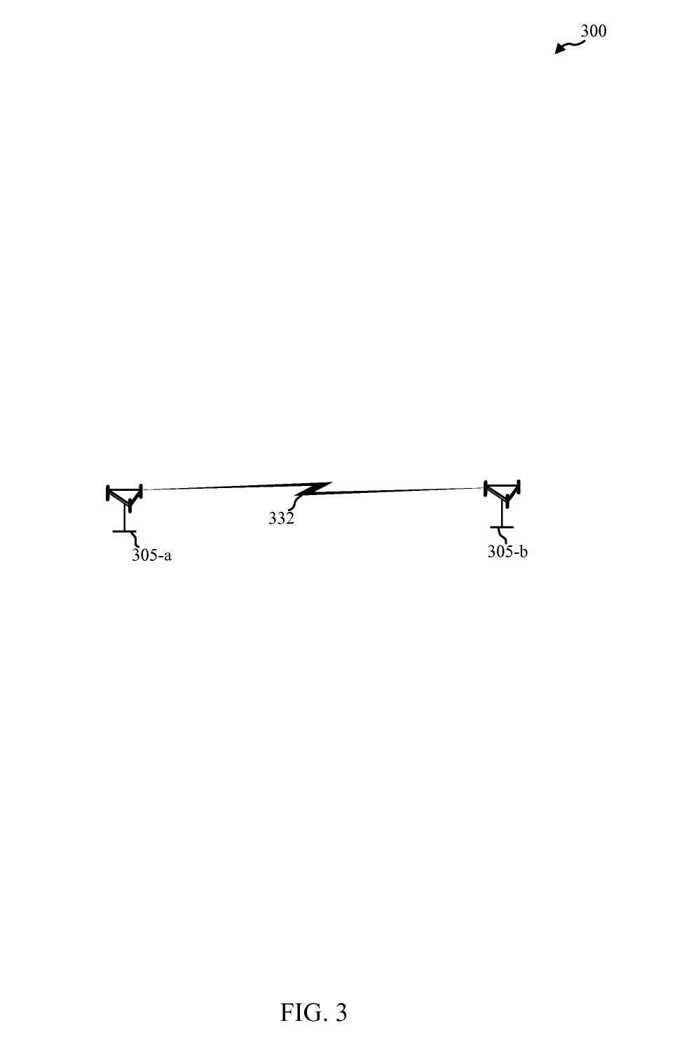

FIG. 3 illustrates aspects of a wireless communications network 300 for supporting wireless backhaul in accordance with various embodiments. FIG. 3 may illustrate, for example, various aspects of wireless networks 100 and/or 200. Wireless communications network 300 includes a node 305-a and a node 305-b in communication over a wireless backhaul link 332. Wireless backhaul in accordance with the described embodiments may be used in a variety of network topologies for communication between a variety of network nodes and/or base stations. For example, node 305-a may be serving as Feeder Base Station (FBS) for node 305-b, which may be a Remote Base Station (RBS). In other examples, nodes 305-a and 305-b are eNBs 105 of wireless networks 100 and/or 200 and wireless backhaul link 332 is an inter-eNB backhaul link (e.g., X2 interface, etc.). In yet other examples, nodes 305-a and 305-b are part of the same base station subsystem (BSS). For example, wireless backhaul link 332 may be used to connect a Base Station Controller (BSC) to one or more Base Transceiver Stations (BTSs) in a UTRAN network architecture, or to connect a Base Band Unit (BBU) to one or more Remote Radio Heads (RRHs) in an E-UTRAN network architecture. Therefore, the term “node,” as used herein, may refer broadly to any node, base station, or subsystem of wireless communication networks 100 and/or 200 applying the disclosed techniques for wireless backhaul.

In embodiments, nodes 305-a and 305-b establish communication via wireless communication link 332. Nodes 305-a and/or 305-b may utilize directional antennas also called narrow-beam point to point (PTP) antennas. Wireless backhaul communication link 332 may utilize licensed or unlicensed spectrum bands in various embodiments. Wireless backhaul communication link 332 may utilize a time-division duplexed (TDD) carrier for communication of backhaul traffic.

Backhaul communications link 332 may be used in wireless communication networks 100 and/or 200 for user plane and/or control plane information. Generally, backhaul traffic may be communicated in packets or frames that are traffic type agnostic and maintain high QoS. For these reasons, backhaul communication links may use error-control techniques such as Automatic Repeat Request (ARQ) and/or Hybrid-ARQ (HARQ).

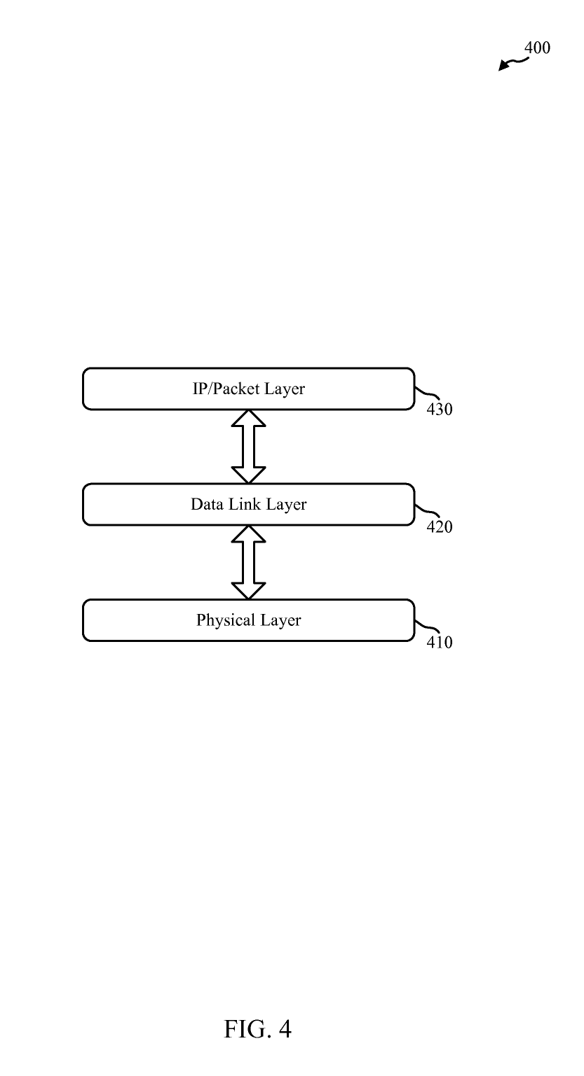

FIG. 4 illustrates a typical protocol architecture 400 for wired and/or wireless backhaul transmissions. The physical layer 410 may include the basic transmission technologies (e.g., hardware and/or transmission medium, etc.). The data link layer 420 controls the transfer of data between network nodes and may provide means for detecting and/or correcting errors that may occur at the physical layer. For example, CRC codes may be used to detect transmission errors. FEC refers to other techniques which may allow the receiver to detect a limited number of errors that may occur during transmission. These techniques may be combined with the use of ARQ/HARQ techniques that use acknowledgements (e.g., ACK/NACK) from the receiver to indicate whether traffic frames or packets were received correctly. The IP/Packet layer 430 may be responsible for addressing and/or packet forwarding.

Latency in user plane and/or control plane may affect various network and/or user performance. For example, performance of transmission control protocol (TCP) communications may be strongly degraded by round trip latency and packet errors. A contributing factor for end-to-end latency as well as latency jitter experienced by packet transmissions is ARQ/HARQ latency.

Referring back to FIG. 3, backhaul data may be transmitted and received by nodes 305-a and 305-b using TDD of wireless backhaul link 332. For purposes of discussion, node 305-a may be an FBS providing backhaul to RBS 305-b. From the perspective of RBS 305-b, a backhaul traffic frame may be made up of one or more transmit subframes and one or more receive subframes. In a typical ARQ/HARQ operation for TDD communication links, a subframe received during a receive time period of the TDD communication link is processed at the data link layer 420 during a transmission of a subframe during the next TDD time period. Processing of received subframes may include decoding the received subframe, determining if the data blocks of the subframe were received correctly (e.g., FEC and/or CRC computation, etc.), and generating ACK/NACK information for the decoded subframe. While subframe processing time at the receiver may vary depending on coding scheme and processor capability, ARQ/HARQ latency for subframes received by RBS 305-b is typically at least two TDD transmission or receive time periods. For example, even if ACK/NACK information is generated during the immediately following TDD subframe for a received subframe, the next transmission subframe from the RBS 305-b may be two TDD subframe periods after the subframe in which the receive processing is performed.

If RBS 305-b detects transmission errors, RBS 305-b informs FBS 305-a of the errors by transmitting the NACK information. FBS 305-a then re-transmits the information (e.g., subframe, data blocks, etc) that was received incorrectly at the RBS 305-b. Re-transmission may take one or more TDD subframes after receiving the NACK information at the FBS 305-a. Thus, the end-to-end latency for retransmission may be three or more TDD subframes depending on the data path complexity of the transmitter and/or receiver.

While unlicensed spectrum bands have great potential for use in backhaul for wireless communication networks, preserving channel reliability for carrier-grade deployments presents substantial challenges. For example, channel reliability including packet errors may be affected by the non-line of sight (NLOS) characteristics of wireless communication network deployments and the bursty interference generated by neighboring wireless networking access points using the unlicensed bands. While ARQ/HARQ latency may not disrupt packet flow where channel reliability is high, ARQ/HARQ latency may be a substantial factor in performance of wireless backhaul in the presence of high path loss and/or bursty interference.

Embodiments are directed to reducing ARQ/HARQ latency using carrier aggregation and cross-carrier ARQ/HARQ signaling. In embodiments, a wireless backhaul transmission link uses multiple paired carriers with complementary TDD subframe timing. In embodiments, backhaul traffic subframes are protected using FEC and/or CRC encoding. A backhaul traffic subframe is received over a first carrier of a paired set of TDD carriers and ACK/NACK information is generated based on decoding and computing the FEC and/or CRC information for the subframe. The ACK/NACK information may be transmitted on the second paired carrier during a transmission subframe on the paired carrier that corresponds to a receive subframe on the first carrier. In embodiments, cross-carrier ARQ/HARQ signaling reduces ARQ/HARQ latency to less than two TDD subframes.

In embodiments, a duplexing filter is configured to reject out-of-band noise from transmission subframes on each of the paired complementary TDD carriers. The duplexing filter may be configured to filter each paired carrier on alternating TDD subframes. The described techniques may be used to provide wireless backhaul for nodes of the wireless communication networks 100 and/or 200 of FIG. 1 and/or FIG. 2. The described techniques may be used to provide wireless backhaul between Feeder Base Stations and Remote Base Stations in wireless communication networks. The described techniques may also be used for inter-eNB wireless backhaul. The described techniques may be used to provide wireless backhaul over unlicensed spectrum bands.

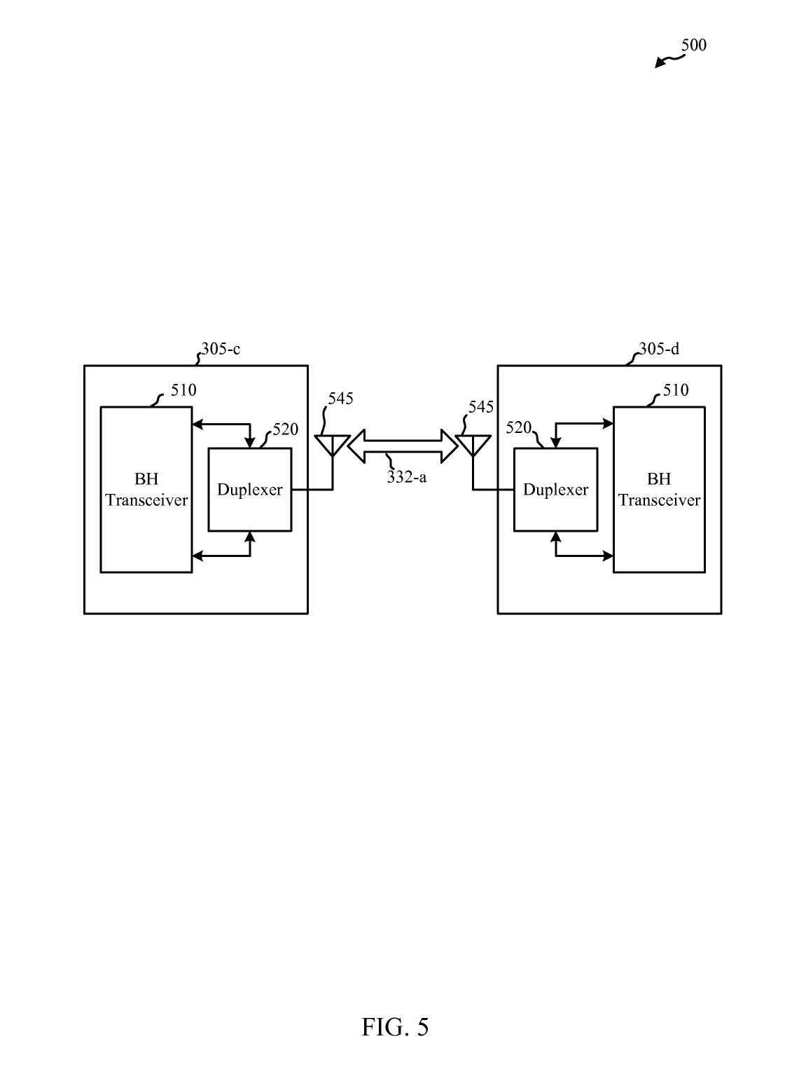

FIG. 5 illustrates a block diagram of a system 500 for reducing ARQ/HARQ latency in wireless backhaul in accordance with various embodiments. FIG. 5 may illustrate, for example, various aspects of wireless networks 100, 200, and/or 300. System 500 includes a first node 305-c and a second node 305-d in communication over wireless backhaul communication link 332-a. Nodes 305-c and/or 305-d may be any nodes of wireless communication systems 100, 200, and/or 300. For example, node 305-a may be serving as Feeder Base Station (FBS) for node 305-b, which may be a Remote Base Station (RBS). In other examples, nodes 305-a and 305-b are eNBs 105 of wireless networks 100 and/or 200 and wireless backhaul link 332 is an inter-eNB backhaul link (e.g., X2 interface, etc.). In yet other examples, nodes 305-a and 305-b are part of the same base station subsystem (BSS). For example, wireless backhaul link 332 may be used to connect a Base Station Controller (BSC) to one or more Base Transceiver Stations (BTSs) in a UTRAN network architecture, or to connect a Base Band Unit (BBU) to one or more Remote Radio Heads (RRHs) in an E-UTRAN network architecture. Therefore, the term “node,” as used herein, may refer broadly to any node, base station, or subsystem of wireless communication networks 100 and/or 200 applying the disclosed techniques for wireless backhaul.

The nodes 305-c and 305-d may include a backhaul transceiver 510 and a duplexer 520. Backhaul transceivers 510 may transmit and receive using antenna(s) 545. Wireless backhaul communication link 332-a may be a narrow-beam PTP communication link over one or more unlicensed spectrum bands. Backhaul transceiver 510 may employ Dynamic Frequency Selection (DFS) to avoid carriers in use by primary users in unlicensed spectrum bands as is known in the art.

In embodiments, backhaul transceiver 510 uses multiple paired carriers with complementary TDD frame timing. In embodiments, backhaul traffic data blocks and/or subframes are protected using FEC and/or CRC encoding. For example, backhaul transceiver 510 may receive a backhaul traffic subframe over a first carrier of a paired set of TDD carriers and generate ACK/NACK information based on decoding and computing the FEC and/or CRC information for the frame. The backhaul transceiver 510 may transmit the ACK/NACK information on the second paired carrier during a transmission subframe on the paired carrier that corresponds to a receive subframe on the first carrier. In embodiments, backhaul transceiver 510 may transmit the ACK/NACK information for a received backhaul traffic subframe less than two subframe periods after receiving the backhaul traffic subframe.

According to the architecture of FIG. 5, duplex filter 520 is configured to reject out-of-band noise from transmission frames on each of the paired complementary TDD carriers. Duplex filter 520 may be configured to filter out-of-band noise from each paired carrier on alternate subframes.

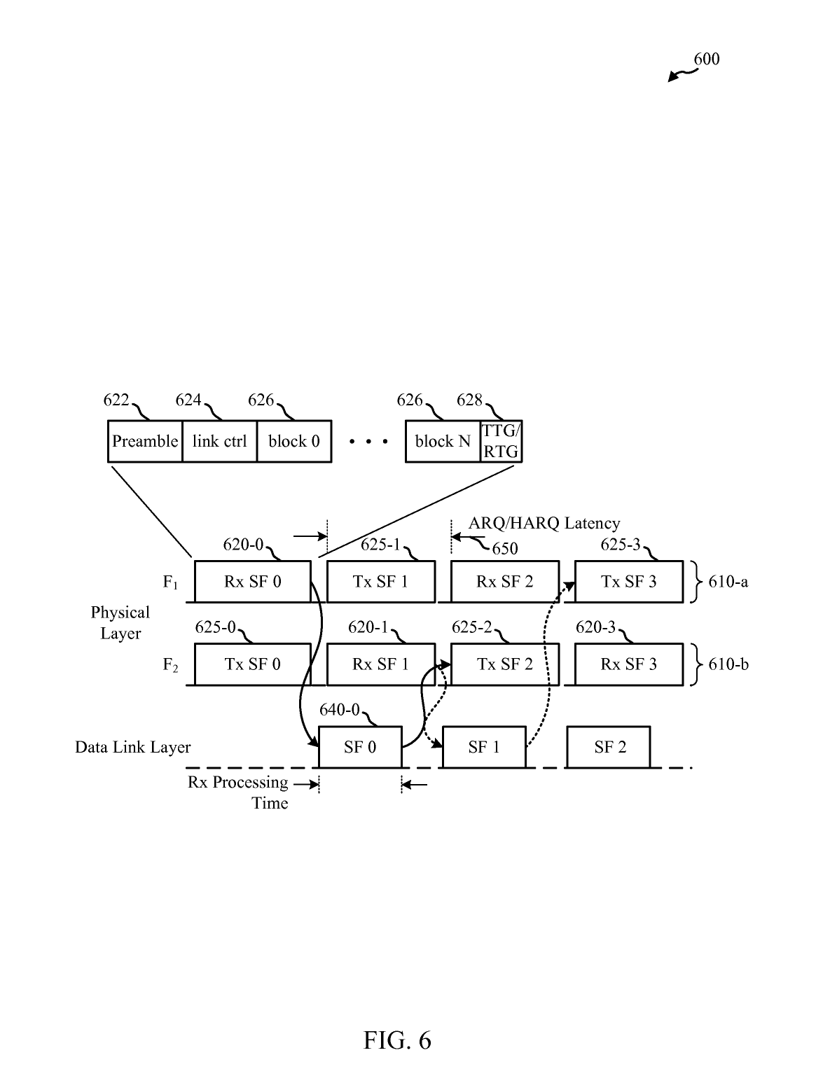

FIG. 6 illustrates a timing diagram 600 for reducing ARQ/HARQ latency in wireless backhaul using paired TDD carriers in accordance with various embodiments. Timing diagram 600 may illustrate, for example, transmission and reception of backhaul subframes over wireless backhaul communication link 332-a in the system of FIG. 5. FIG. 6 illustrates paired TDD carriers 610-a and 610-b of a wireless backhaul communication link. Carriers 610-a and 610-b may be adjacent carriers or non-adjacent carriers.

FIG. 6 may illustrate, for example, carriers 610-a and 610-b from the perspective of an RBS node 305 in a wireless backhaul system 300. For example, received subframes (e.g., Rx SF 620-0, etc.) may indicate subframes transmitted from an FBS to the RBS, while transmit subframes (e.g., Tx SF 625-0, etc.) may indicate subframes transmitted from the RBS to the FBS. Each subframe 620 and/or 625 may include a preamble 622, a link control field 624, and a number N of data traffic blocks 626. The data traffic blocks may include FEC and/or CRC information for error detection and/or correction. Time gaps 628 (e.g., Transmit/receive Transition Gap (TTG), Receive/transmit Transition Gap (RTG), etc.) may be inserted between subframes to prevent overlap of transmit and received subframes at the receiver. The link control field 624 may include ACK/NACK information for one or more previously received subframes 620.

The RBS node 305 may include a carrier aggregation duplexer for duplex filtering carrier 610-a from carrier 610-b and vise-versa. For example, during the TDD subframe period corresponding to transmitted frame 625-0 and receive frame 620-0, the carrier aggregation duplexer may filter carrier 610-b from the receive channel such that subframe 620-0 can be received without experiencing excessive out-of-band interference from the transmission of subframe 625-0. The carrier aggregation duplexer may switch to filter carrier 610-a during the TDD subframe period corresponding to transmitted subframe 625-1 and receive subframe 620-1 such that transmission of subframe 625-1 does not cause out-of-band interference to the receive channel during reception of subframe 620-1.

In some embodiments, ARQ/HARQ information for subframes received on carrier 610-a may be transmitted during at least a partially overlapping transmit subframe on carrier 610-b. In this context, “overlapping” refers to a receive subframe period and a transmit subframe period overlapping in time. Thus, for example, the RBS may receive subframe 620-0 and process subframe 620-0 as indicated by receive subframe processing block 640-0. As illustrated by the solid arrows, ACK/NACK information for the received subframe 620-0 may be transmitted during transmit subframe 625-2. The ARQ/HARQ latency for paired TDD carriers using cross-carrier HARQ/ARQ may be, as illustrated in FIG. 6, less than two TDD subframe periods and, in embodiments, approximately one TDD subframe period. As indicated by the dashed arrows, ARQ/HARQ information for subframes received on carrier 610-b may be transmitted on carrier 610-a with substantially the same HARQ/ARQ latency. Thus, as compared to HARQ/ARQ latency in typical TDD systems, the cross-carrier HARQ/ARQ using paired TDD carriers may reduce HARQ/ARQ latency by at least one TDD subframe period.

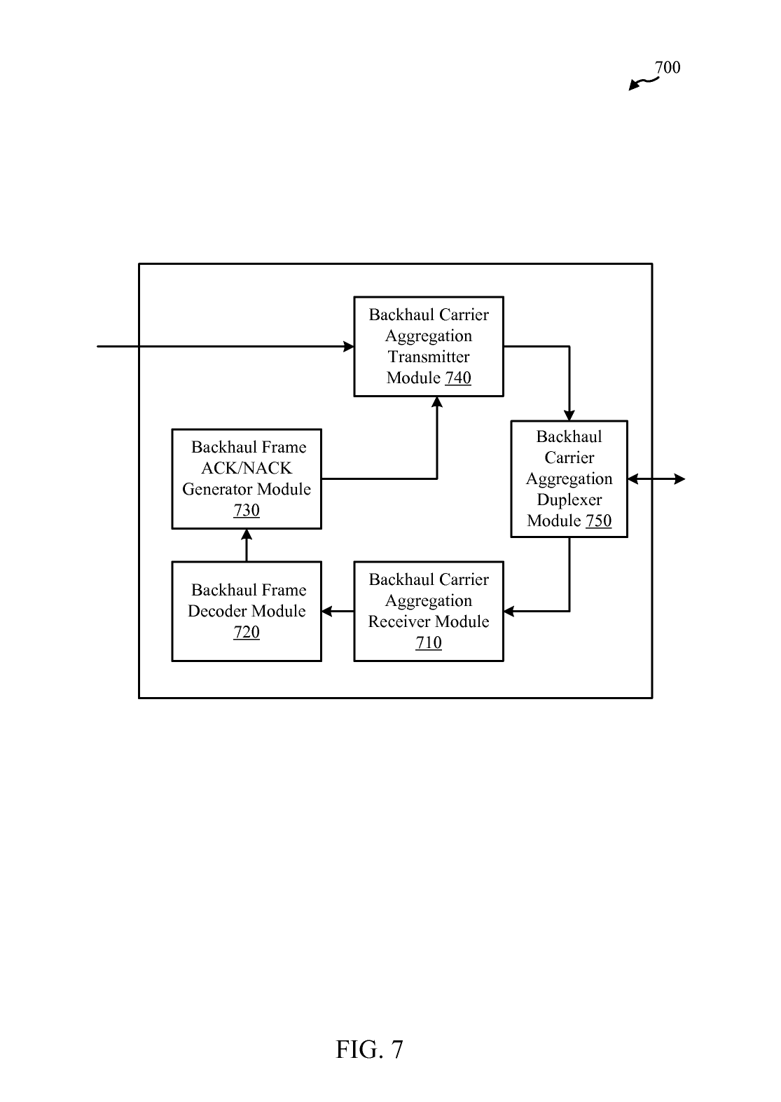

Turning next to FIG. 7, a block diagram of a device 700 that may be employed for reducing ARQ/HARQ latency in wireless backhaul using paired TDD carriers is illustrated in accordance with various embodiments. The device 700 may illustrate one or more aspects of nodes 305 described with reference to FIG. 3 and/or FIG. 5. The device 700 may also be a processor. The device 700 may include a backhaul carrier aggregation transmitter 740, a backhaul carrier aggregation duplexer 750, a backhaul carrier aggregation receiver module 710, a backhaul frame decoder module 720, and a backhaul frame ACK/NACK generator module 730. Each of these modules may be in communication with each other.

The backhaul carrier aggregation receiver module 710 may receive backhaul subframes over a first time division duplexed carrier of a first wireless backhaul communications link. The backhaul frame decoder module 720 may decode the backhaul subframes. The backhaul ACK/NACK generator module 730 may generate ACK/NACK indicators based on the decoded backhaul subframes. The backhaul carrier aggregation transmitter module 740 may transmit the ACK/NACK indicator over a second time division duplexed carrier of the first wireless backhaul communications link. The backhaul carrier aggregation duplexer 750 may duplex filter the first and second time division duplexed carriers. The backhaul carrier aggregation duplexer 750 may be configured to switch to filter each of a paired set of TDD carriers during alternating TDD subframe periods.

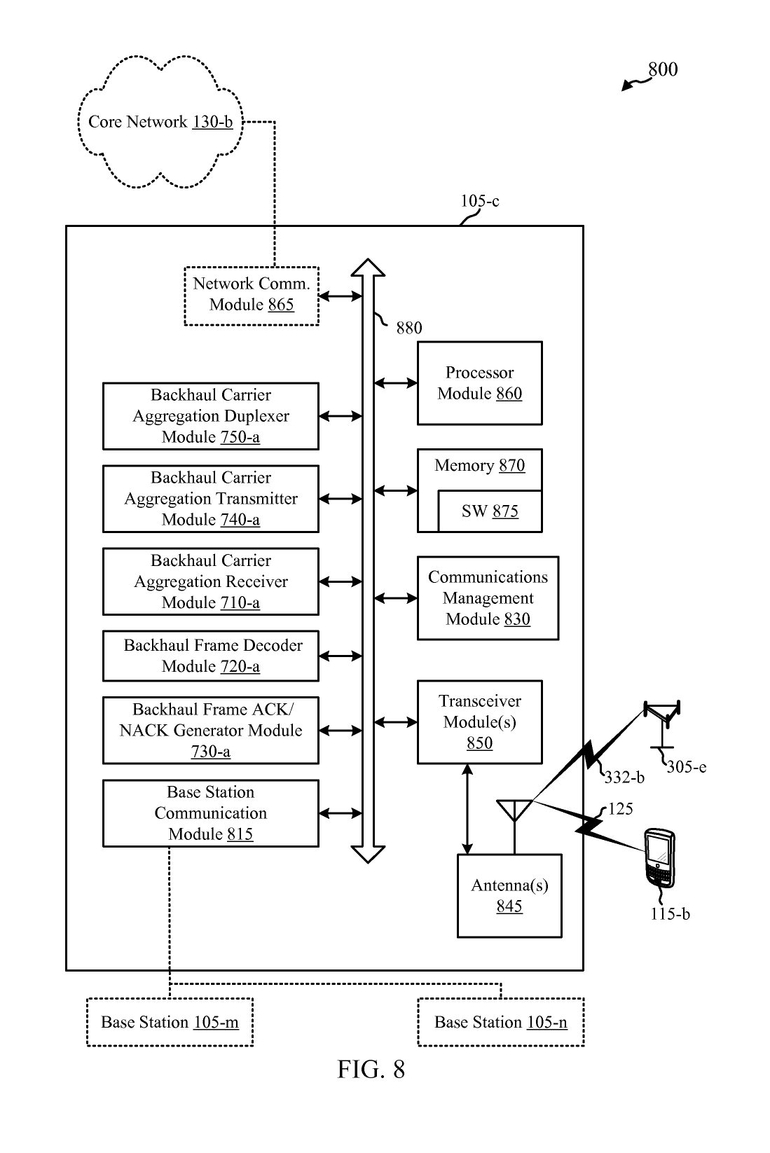

FIG. 8 shows a block diagram of a communications system 800 that may be configured for reducing ARQ/HARQ latency in wireless backhaul using paired TDD carriers in accordance with various embodiments. This system 800 may be an example of aspects of the system 100 depicted in FIG. 1, system 200 of FIG. 2, and/or system 300 of FIG. 3. The system 800 includes a base station 105-c configured for communication with node 305-e over wireless backhaul link 332-b. Base station 105-c may be, for example, an eNB 105 as illustrated in systems 100 and/or 200.

In some cases, the base station 105-c may have one or more wired backhaul links. Base station 105-c may be, for example, a macro eNB 105 having a wired backhaul link to the core network 130-c. Base station 105-c may be an FBS for node 305-g (e.g., where node 305-e may be a femto eNB, pico eNB, and the like) via wireless backhaul communication link 332-b. Base station 105-c may also communicate with other base stations 105, such as base station 105-m and base station 105-n via inter-base station wired communication links Each of the base stations 105 may communicate with UEs 115 using different wireless communications technologies, such as different Radio Access Technologies. In some cases, base station 105-c may communicate with other base stations such as 105-m and/or 105-n utilizing base station communication module 815. In some embodiments, base station communication module 815 may provide an X2 interface within an LTE/LTE-A wireless communication network technology to provide communication between some of the base stations 105. In some embodiments, base station 105-c may communicate with other base stations through core network 130-b.

In some cases, the base station 105-c may not have wired backhaul links with core network 130-b and/or other base stations 105. For example, base station 105-c may be an RBS and backhaul may be provided for base station 105-c by node 305-g via wireless backhaul communication link 332-b. Node 305-g may be a core entity (e.g., MME 232, Serving GW 234, etc.) or another base station 105.

The components for base station 105-c may be configured to implement aspects discussed above with respect to base stations 105 and/or 305 and/or device 700 of FIG. 7 and may not be repeated here for the sake of brevity. For example, the backhaul carrier aggregation duplexer module 730-a may perform similar functions as the backhaul carrier aggregation duplexer module 730, the backhaul carrier aggregation transmitter module 740-a may perform similar functions as the backhaul carrier aggregation transmitter module 740, the backhaul carrier aggregation receiver module 710-a may perform similar functions as the backhaul carrier aggregation receiver module 710, the backhaul frame decoder module 720-a may perform similar functions as the backhaul frame decoder module 720, and the backhaul frame ACK/NACK generator module 730-a may perform similar functions as the backhaul frame ACK/NACK generator module 730. By way of example, these modules may be components of the base station 105-c in communication with some or all of the other components of the base station 105-c via bus system 880. Alternatively, functionality of these modules may be implemented as a component of the transceiver module 850, as a computer program product, and/or as one or more controller elements of the processor module 1060.

The base station 105-c may include antennas 845, transceiver modules 850, memory 870, and a processor module 860, which each may be in communication, directly or indirectly, with each other (e.g., over bus system 880). The transceiver modules 850 may be configured to communicate bi-directionally, via the antennas 845, with the user equipment 115-e, which may be a multi-mode user equipment. The transceiver module 850 (and/or other components of the base station 105-c) may also be configured to communicate bi-directionally, via the antennas 845, with one or more other nodes 305.

The memory 870 may include random access memory (RAM) and read-only memory (ROM). The memory 870 may also store computer-readable, computer-executable software code 875 containing instructions that are configured to, when executed, cause the processor module 860 to perform various functions described herein (e.g., call processing, database management, message routing, etc.). Alternatively, the software 875 may not be directly executable by the processor module 860 but be configured to cause the computer, e.g., when compiled and executed, to perform functions described herein.

The processor module 860 may include an intelligent hardware device, e.g., a central processing unit (CPU) such as those made by Intel® Corporation or AMD®, a microcontroller, an application-specific integrated circuit (ASIC), etc. The processor module 860 may include various special purpose processors such as encoders, queue processing modules, base band processors, radio head controllers, digital signal processors (DSPs), and the like.

The transceiver modules 850 may include a modem configured to modulate the packets and provide the modulated packets to the antennas 845 for transmission, and to demodulate packets received from the antennas 845. The base station 105-c may include multiple transceiver modules 850, each with one or more associated antennas 845. For example, the base station 105-c may include a transceiver module 850 for communication with UEs 115 using a Radio Access Technology such as LTE/LTE-A, and a separate transceiver module 850 for communication with other base stations using the backhaul communication techniques described above.

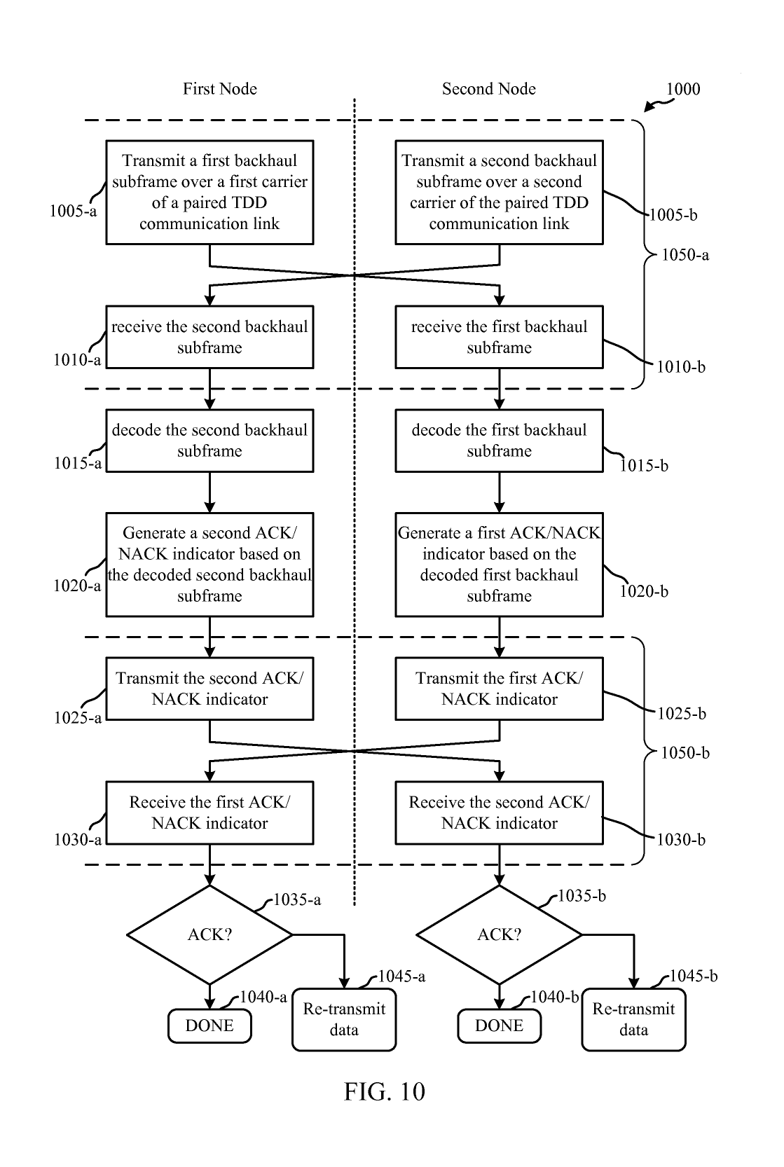

According to the architecture of FIG. 10, the base station 105-c may further include a communications management module 830. The communications management module 830 may manage communications with other base stations 105. The communications management module may include a controller and/or scheduler for controlling communications with UEs 115 in cooperation with other base stations 105. For example, the communications management module 830 may perform scheduling for transmissions to UEs 115 and/or various interference mitigation techniques such as beamforming and/or joint transmission.

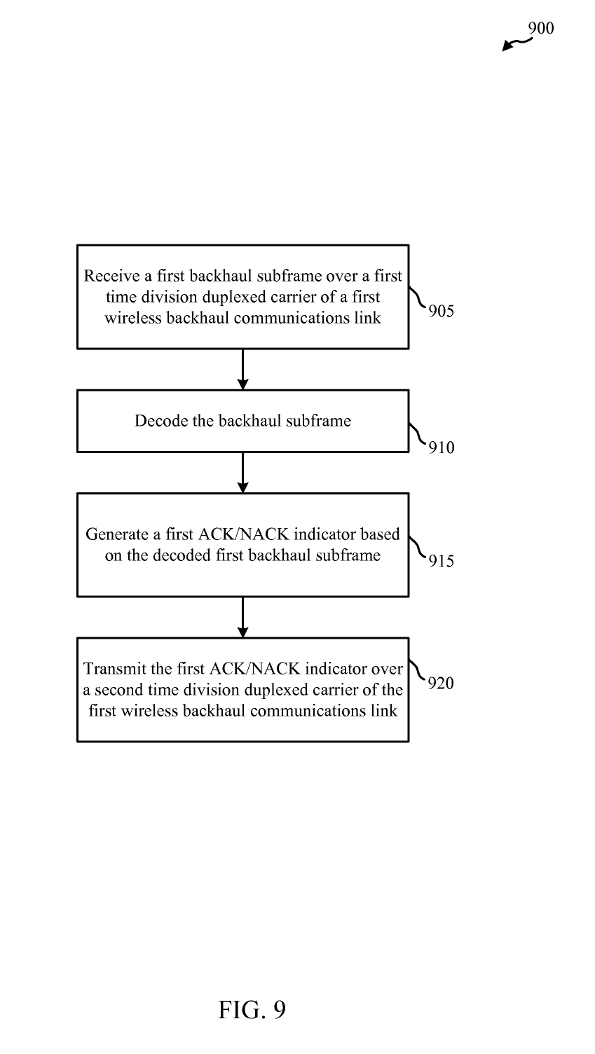

FIG. 9 illustrates a method 900 for reducing ARQ/HARQ latency in wireless backhaul using paired TDD carriers in accordance with various embodiments. The method 900 may be used by nodes 305 of FIGS. 3, and/or 5. As described above, these nodes 305 may be any node or subsystem of wireless communication networks 100 and/or 200 of FIGS. 1 and/or 2, including base stations 105.

Method 900 begins at block 905 where a first backhaul subframe is received over a first time division duplexed carrier of a first wireless backhaul communications link. For example, an FBS or RBS may receive a backhaul traffic subframe during a TDD subframe period. At block 910, the receiving node decodes the backhaul subframe. At block 915, the node generates a first acknowledgement/negative acknowledgement (ACK/NACK) indicator based on the decoded first backhaul subframe. Generating the ACK/NACK information may include, for example, calculating and checking FEC and/or CRC information for the decoded backhaul subframe. At block 920, the node transmits the first ACK/NACK indicator over a second time division duplexed carrier of the first wireless backhaul communications link.

FIG. 10 illustrates a method 1000 for reducing ARQ/HARQ latency in wireless backhaul using paired TDD carriers in accordance with various embodiments. The method 1000 may be used by nodes 305 of FIGS. 3, and/or 5. As described above, these nodes 305 may be any node or subsystem of wireless communication networks 100 and/or 200 of FIGS. 1 and/or 2, including base stations 105.

Method 1000 may start at blocks 1005-a, where a first node transmits a first backhaul subframe over a first carrier of a TDD communication link. At block 1005-b, a second node may transmit a second backhaul subframe over a second carrier of the paired TDD communication link within at least a partially overlapping subframe period corresponding to transmission of a first backhaul subframe over the first carrier. As illustrated in FIG. 10, the second node may receive the first backhaul subframe at block 1010-b, while the first node may receive the second backhaul subframe at block 1010-a. Blocks 1005 and 1010 may be performed by the first and second nodes during a first TDD subframe 1050-a.

At block 1015-a, the first node may decode the second backhaul subframe. At block 1020-a, the first node may generate ACK/NACK information for the decoded second subframe. At block 1015-b, the second node may decode the first backhaul subframe. At block 1020-b, the second node may generate ACK/NACK information for the decoded first subframe.

At block 1025-a, the first node may transmit the second ACK/NACK information. At block 1025-b, the second node may transmit the first ACK/NACK information. At blocks 1030-a, and 1030-b, the first and second nodes may receive the transmitted first and second ACK/NACK information within at least a partially overlapping subframe period. As illustrated in Blocks 1025 and 1030 may be performed by the first and second nodes during a second TDD subframe 1050-b.

Upon receiving the first ACK/NACK information for the first backhaul subframe at block 1030-a, the first node determines at block 1035-a, based on the ACK/NACK information, whether to re-transmit data of the first backhaul subframe at block 1045-a, or whether the data was received correctly and the transmission is done at block 1040-a. Similarly, the second node determines at block 1035-b, based on the ACK/NACK information for the second subframe, whether to re-transmit data of the second backhaul subframe at block 1045-b, or whether the data was received correctly and the transmission is done at block 1040-b.

The detailed description set forth above in connection with the appended drawings describes exemplary embodiments and does not represent the only embodiments that may be implemented or that are within the scope of the claims. The term “exemplary” used throughout this description means “serving as an example, instance, or illustration,” and not “preferred” or “advantageous over other embodiments.” The detailed description includes specific details for the purpose of providing an understanding of the described techniques. These techniques, however, may be practiced without these specific details. In some instances, well-known structures and devices are shown in block diagram form in order to avoid obscuring the concepts of the described embodiments.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a digital signal processor (DSP), an application-specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, multiple microprocessors, one or more microprocessors in conjunction with a DSP core, or any other such configuration.

The functions described herein may be implemented in hardware, software/firmware, or combinations thereof. If implemented in software/firmware, the functions may be stored on or transmitted over as one or more instructions or code on a computer-readable medium. Other examples and implementations are within the scope and spirit of the disclosure and appended claims. For example, due to the nature of software/firmware, functions described above can be implemented using software/firmware executed by, e.g., a processor, hardware, hardwiring, or combinations thereof. Features implementing functions may also be physically located at various positions, including being distributed such that portions of functions are implemented at different physical locations. Also, as used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C).

Computer-readable media includes both computer storage media and communication media including any medium that facilitates transfer of a computer program from one place to another. A storage medium may be any available medium that can be accessed by a general-purpose or special-purpose computer. By way of example, and not limitation, computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software/firmware is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the generic principles defined herein may be applied to other variations without departing from the spirit or scope of the disclosure. Throughout this disclosure the term “example” or “exemplary” indicates an example or instance and does not imply or require any preference for the noted example. Thus, the disclosure is not to be limited to the examples and designs described herein but is to be accorded the widest scope consistent with the principles and novel features disclosed herein.

1. A method for wireless backhaul communications in a wireless communications network, the method comprising:
receiving, at a first node of the wireless communications network, a first backhaul subframe over a first time division duplexed carrier of a wireless backhaul communications link between the first node and a second node of the wireless communications network;
decoding the first backhaul subframe;
generating a first acknowledgement/negative acknowledgement (ACK/NACK) indicator based on the decoded first backhaul subframe;
transmitting, from the first node to the second node, the first ACK/NACK indicator over a second time division duplexed carrier of the wireless backhaul communications link; and
transmitting, within at least a partially overlapping subframe period corresponding to reception of the first backhaul subframe, a second backhaul subframe over the second carrier to the second node.

2. The method of claim 1, further comprising:
receiving, within at least a partially overlapping subframe period corresponding to transmitting the first ACK/NACK indicator for the first backhaul subframe, a second ACK/NACK indicator associated with reception at the second node of the second backhaul subframe.

3. The method of claim 2, further comprising:
filtering, at the first node, the transmission of the second backhaul subframe within the at least partially overlapping subframe period corresponding to reception of the first backhaul subframe.

4. The method of claim 1, wherein transmission periods for the first node on the second time division duplexed carrier at least partially overlap with reception periods for the first node on the first time division duplexed carrier.

5. The method of claim 1, wherein decoding the first backhaul subframe comprises performing a cyclic redundancy check (CRC) on the first backhaul subframe.

6. The method of claim 1, further comprising:
modulating and coding, at the first node, a second backhaul subframe for transmission during a subframe period immediately following reception of the first backhaul subframe, the modulation and coding of the second backhaul subframe performed prior to completion of the decoding of the first backhaul subframe.

7. The method of claim 1, wherein the first ACK/NACK indicator is transmitted within a transmission subframe of the second time division duplexed carrier less than two subframe periods after receiving the first backhaul subframe.

8. The method of claim 1, wherein the first ACK/NACK indicator indicates unsuccessful receipt of the first backhaul subframe at the first node, the method further comprising:
receiving a re-transmission of the first backhaul subframe from the second node over the first time division duplexed carrier.

9. The method of claim 1, wherein the first and second time division duplexed carriers comprise carriers of a shared spectrum band open for use by wireless local area networks (WLANs).

10. A computer program product for wireless backhaul between a first node and a second node of a wireless communications network, comprising:
a non-transitory computer-readable medium comprising: code for causing a computer to receive, at a first node of the wireless communications network, a first backhaul subframe over a first time division duplexed carrier of a wireless backhaul communications link between the first node and a second node;
code for causing the computer to decode the first backhaul subframe;
code for causing the computer to generate a first acknowledgement/negative acknowledgement (ACK/NACK) indicator based on the decoded first backhaul subframe;
code for causing the computer to transmit, from the first node to the second node, the first ACK/NACK indicator over a second time division duplexed carrier of the wireless backhaul communications link;
code for causing the computer to transmit, within at least a partially overlapping subframe period corresponding to reception of the first backhaul subframe, a second backhaul subframe over the second carrier to the second node.

11. The computer program product of claim 10, further comprising:
code for causing the computer to receive, within at least a partially overlapping subframe period corresponding to transmitting the first ACK/NACK indicator for the first backhaul subframe, a second ACK/NACK indicator associated with reception at the second node of the second backhaul subframe.

12. A communications device for wireless backhaul communications between a first node and a second node of a wireless communications network, comprising:
at least one processor configured to:
receive, at the first node, a first backhaul subframe over a first time division duplexed carrier of a wireless backhaul communications link between the first node and the second node;
decode the first backhaul subframe;
generate a first acknowledgement/negative acknowledgement (ACK/NACK) indicator based on the decoded first backhaul subframe;
transmit, from the first node to the second node, the first ACK/NACK indicator over a second time division duplexed carrier of the wireless backhaul communications link; and
transmit, within at least a partially overlapping subframe period corresponding to reception of the first backhaul subframe, a second backhaul subframe over the second carrier to the second node.

13. The communications device of claim 12, wherein the at least one processor is further configured to:
receive, within at least a partially overlapping subframe period corresponding to transmitting the first ACK/NACK indicator for the first backhaul subframe, a second ACK/NACK indicator associated with reception at the second node of the second backhaul subframe.

14. The communications device of claim 13, wherein the at least one processor is further configured to:
filter, at the first node, the transmission of the second backhaul subframe within the at least partially overlapping subframe period corresponding to reception of the first backhaul subframe.

15. The communications device of claim 12, wherein transmission periods for the first node on the second time division duplexed carrier at lease partially overlap with reception periods for the first node on the first time division duplexed carrier.

16. The communications device of claim 12, wherein decoding the first backhaul subframe comprises performing a cyclic redundancy check (CRC) on the first backhaul subframe.

17. The communications device of claim 12, wherein the at least one processor is further configured to:
modulate and code, at the first node, a second backhaul subframe for transmission during a subframe period immediately following reception of the first backhaul subframe, the modulation and coding of the second backhaul subframe performed prior to completion of the decoding of the first backhaul subframe.

18. The communications device of claim 12, wherein the first ACK/NACK indicator is transmitted within a transmission subframe of the second time division duplexed carrier less than two subframe periods after receiving the first backhaul subframe.

19. The communications device of claim 12, wherein the first ACK/NACK indicator indicates unsuccessful receipt of the first backhaul subframe at the first node, and wherein the at least one processor is further configured to:
receive a re-transmission of the first backhaul subframe from the second node over the first time division duplexed carrier.

20. The communications device of claim 12, wherein the first and second time division duplexed carriers comprise carriers of a shared spectrum band open for use by wireless local area networks (WLANs).
